(19) United States
(12) Patent Application Publication
(10) Pub. No.: US 2011/0190037 A1
(43) Pub. Date: Aug. 4, 2011

(54) DEVICE COMPRISING A HYDROGEN-AIR OR METHANOL-AIR TYPE FUEL CELL

(75) Inventors: Frédéric Cantin, Tours (FR); Vincent Faucheux, Lans En Vercors (FR)

(73) Assignees: STMicroelectronics (Tours) SAS, Tours (FR); Commissariat à l'Energie Atomique, Paris (FR)

(21) Appl. No.: 13/016,285

(22) Filed: Jan. 28, 2011

(30) Foreign Application Priority Data
Jan. 29, 2010 (FR) 10/50626

(51) Int. Cl. H04M 1/00; H01M 8/04; H01M 8/06

(52) U.S. Cl. 455/573; 429/444; 429/414

(57) ABSTRACT

A device comprising a chamber in which a hydrogen-air or methanol-air type fuel cell is arranged, the chamber including an upper wall in which an opening is formed, a lower wall on which the cell is arranged so that the surface of exposure to air of the cell faces the upper wall, and a fan arranged in the opening.

### CROSS REFERENCE TO RELATED APPLICATIONS

This application claims the priority benefit of French patent application number 10/50626, filed on Jan. 29, 2010, entitled “Device Comprising a Hydrogen-Air or Methanol-Air Type Fuel Cell,” which is hereby incorporated by reference to the maximum extent allowable by law.

### BACKGROUND OF THE INVENTION

1. Field of the Invention

The present invention relates to fuel cells of hydrogen-air or methanol-air type. It more specifically relates to a device comprising such cells and capable of being used in variable environments.

2. Discussion of the Related Art

Hydrogen-air fuel cells are formed of one or several silicon wafers, each forming a cell.

A known cell is formed on a support wafer, for example, a silicon wafer. An active stack interposed between a lower electrode (forming the anode) and an upper electrode (forming the cathode) is arranged on this support by techniques of the type used in microelectronics.

To operate the cell, hydrogen is injected on the lower surface side. The upper surface is exposed to air, which contains oxygen. The hydrogen molecules are broken up into H+ protons and electrons. The electrons are collected at the anode level while the protons recombine with the oxygen of the ambient air to form water microdroplets.

A fuel cell is capable of being assembled in portable electronic devices, such as very low power lithium-ion type battery chargers. The cell environment is then variable and difficult to control.

It has been observed that in the absence of airing, the water droplets generated on the upper surface side of the cell cathode are capable of forming a water film, which prevents the arrival of oxygen: the cell is “flooded”.

Conversely, if a cell is arranged in an unstable environment, air drafts at the cell surface are likely to “dry” it. The cell is no longer in an environment sufficiently saturated with humidity. The cell efficiency decreases and, when restarted after idle periods, the cell is unable to immediately provide the expected nominal voltage and current.

### SUMMARY OF THE INVENTION

An object of an embodiment of the present invention is to provide a fuel cell avoiding at least some of the disadvantages of prior fuel cells.

Another object of an embodiment of the present invention is to provide a device comprising a fuel cell with improved efficiency.

Thus, an embodiment of the present invention provides a device comprising a chamber in which a hydrogen-air or methanol-air type fuel cell is arranged, the chamber comprising:

an upper wall in which an opening is formed,

a lower wall on which the cell is arranged so that the surface of exposure to air of the cell faces the upper wall, and

a fan arranged in the opening.

According to an embodiment of the present invention, the fan is in central position relative to the cell.

According to an embodiment of the present invention, the fan has a lateral dimension ranging between 5 and 25 mm, preferably between 10 and 20 mm.

According to an embodiment of the present invention, the fan has a surface area ranging between 25 and 425 mm², preferably between 100 and 400 mm².

According to an embodiment of the present invention, the fan is powered by the cell.

According to an embodiment of the present invention, the internal surface of the upper wall comprises a sheet of a humidity-absorbing material communicating through an auxiliary opening with the outer environment of the chamber.

Another embodiment of the present invention provides a battery charger for a cell phone, comprising a device such as described hereabove.

The foregoing objects, features, and advantages of the present invention will be discussed in detail in the following non-limiting description of specific embodiments in connection with the accompanying drawings.

### BRIEF DESCRIPTION OF THE DRAWINGS

FIG. 1 is a simplified cross-section view of a device comprising a fuel cell;

FIG. 2 is a simplified perspective view of a device comprising a fuel cell according to an embodiment of the present invention; and

FIGS. 3 and 4 are transverse cross-section views along plane III-III of FIG. 2 illustrating the device operation.

### DETAILED DESCRIPTION

For clarity, the same elements have been designated with the same reference numerals in the different drawings, which have been drawn out of scale.

To avoid “dry up” of the cell, it may be provided to arrange the cell in a chamber provided with openings. Thus, the cell can be displaced while being less sensitive to environmental instabilities, such as air drafts.

To obtain this stable environment in the vicinity of the cell, a small number of openings may be formed in the upper wall of the chamber. However, the diffusion of oxygen into the chamber would risk being limited, and thus insufficient for the proper operation of the cell. Further, the atmosphere in the chamber would risk being quickly overloaded with water.

It could then be decided to increase the number and/or the size of the openings. The instability would then however be enhanced. Indeed, air drafts would be generated at the upper surface of the cell and the cell would tend to “dry up”.

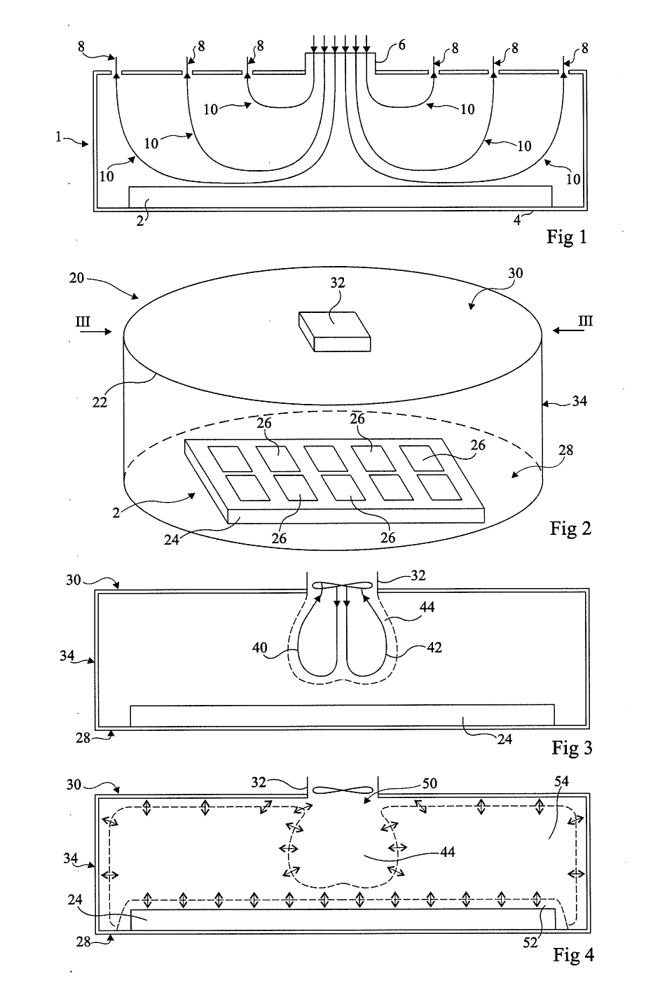

To overcome the above-discussed disadvantages, it may be provided to use a device 1 such as shown in FIG. 1.

Device 1 comprises a fuel cell 2 arranged in a chamber 4. The chamber comprises an upper wall in which is fitted a fan 6. Further, a plurality of openings 8 are formed in this surface. Fan 6 has the function of letting air flows 10 penetrate into the chamber. Such air flows run close to the upper surface of cell 2 and load the cell with water vapor. The flows then come out of chamber 4 through openings 8. A small improvement of the cell efficiency can be noted.

To further improve the efficiency of a fuel cell, the Applicants provide the device described hereafter.

FIG. 2 is a very simplified perspective view of a device 20 comprising a chamber 22 in which a hydrogen-air fuel cell 2 is arranged.

Cell 2 comprises a support 24. The support comprises a plurality of silicon wafers 26 in contact with the ambient air, which is the oxygen reservoir of chamber 22. The lower cell wall is in contact with a hydrogen source in a way which does not appear in the drawings.

Chamber 22 comprises a lower wall 28 on which cell 2 is arranged. Chamber 22 also comprises an upper wall 30 opposite to the lower wall in which an opening is formed. A mill-type fan 32 is arranged at the level of the opening. The opening is formed in this wall so that the fan substantially faces cell 2. Advantageously, the fan is in central position with respect to cell 2. Lower and upper walls 28 and 30 are connected by a lateral wall 34.

Fan 32 has a lateral dimension ranging between 5 and 25 mm, preferably between 10 and 20 mm. The fan has a surface area ranging between 25 and 425 mm^{2,} preferably between 100 and 400 mm^{2.} Further, the fan has a height ranging between 2 and 10 mm, preferably between 4 and 6 mm.

FIGS. 3 and 4 are transverse cross-section views along plane III-III of FIG. 2.

Device 20 operates as follows. As illustrated in FIG. 3, the air outside of chamber 22 penetrates into the chamber through a central portion of fan 32. The incoming air is called fresh since it is loaded with oxygen. Two loops 40 and 42 have been symbolically shown. Loops 40 and 42 penetrating into the chamber substantially through the center of the fan are directed downwards, that is, towards support 24. Air flows 40 and 42 rise back up towards upper wall 30 without touching the upper surface of cell 2. Air flows 40 and 42 come out of chamber 22 through a peripheral portion of fan 32. The air flows are substantially confined in a well 44 symbolized by dotted lines. The well is arranged under fan 32. It can also be observed that well 44 does not extend all the way to the upper surface of cell 2. The air circulation only occurs in well 44, aside from the cell.

In operation, cell 2 radiates heat. At equilibrium, as illustrated in FIG. 4, the cell operation enables to approximately distinguish three distinct thermal areas 50, 52, and 54. First area 50, said to be cold, is formed of well 44 substantially arranged at the center of chamber 22. Well 44 is essentially formed of fresh air containing little water, entering through the central portion of fan 32. Area 50 also comprises portions in the vicinity of lateral wall 34 and of upper portion 30. The depth of these portions especially depends on the construction and on the thickness of the lateral wall and of the upper wall.

So-called hot area 52 is arranged close to wafers 26 along the upper surface of support 24 of cell 2. In operation, the air present in area 52 thus has a temperature greater than the temperature of the air of area 50.

Intermediary area 54 is defined between areas 50 and 52. The temperature of area 54 varies between the temperature of area 50 and that of area 52.

Area 54 contains stagnant air (almost unstirred), due to the confinement of chamber 22 and despite the activity of fan 32. Further, this air is, due to its contact with area 52 and to the cell activity, is hot, damp, and depleted of oxygen.

Conversely, in area 44, the perpetually stirred air is fresh, with a temperature and humidity and oxygen contents substantially equal to those of the outer air.

The concentration differences cause a gaseous diffusion, through the surface where areas 44 and 52 intersect. This gaseous diffusion provides, among things, the oxygen supply of the cell and a partial evaporation of water vapor via fan 32.

The oxygen supply improves as the intersection surface area grows larger, which directly depends on the shape of loops 42 which have been formed by means of fan 32. The shape shown in FIG. 3, with loops connecting the center and the periphery of the fan, is the most favorable experimentally found. If the fan is off or removed, these loops disappear and the intersection surface between 44 and 54 becomes that of the fan opening, which is four times smaller in the considered example.

The high temperature in area 54 maintains a high humidity rate in the chamber.

The limited water vapor exhaust by fan 32 enables the occurrence of a humidity stabilization mechanism: condensation on upper wall 30 (coldest portion of chamber 22). The humidity rate in area 54 will then settle, independently from the activity of fan 32, at a high value only depending on the temperature difference.

The water condensed on upper wall 30 may be drained off by a sheet of a humidity-absorbing material such as a blotting paper appropriately placed on the internal surface of wall 30, and conveying (via an auxiliary opening in the wall, of a size smaller than that of the opening made to install fan 32, the auxiliary opening being closed by the blotting paper) the liquid water by capillary action towards a drying surface external to chamber 22.

Such phenomena of natural diffusion of air from a hot area to a cold area, symbolized by double arrows in FIG. 4, take part in the creation of a stable and sufficiently humid air environment, especially in the vicinity of wafers 26. Diffusion phenomena provide an air containing a sufficient amount of water to maintain an optimum humidity rate close to the wafers. The thermal diffusion close to the cell predominates over the air circulation, which is negligible.

Fan 32 has the function of regulating the incoming of descending air flows loaded with oxygen and the outlet of ascending air flows loaded with water. Accordingly, there is a stable humidity rate in the chamber. Further, there is no air draft in the vicinity of wafers 26. The incoming of oxygen and the draining off of water are regular. Further, the system is self-regulated. Indeed, it is not necessary to use a fan control unit.

The Applicants have noted that auxiliary openings other than the opening made to install fan 32 may be formed in upper wall 30 of chamber 22, provided for the general surface area defined by these openings to be very small, for example, smaller than 40% of the surface area of the opening formed at the fan level, and preferably smaller than 30% of this surface area. In this configuration, part of the air injected into chamber 22 by fan 32 tends to come out of it through these openings. Since their surface areas are much smaller than the surface area of the opening formed at the fan level, no instabilities especially likely to “dry” wafers 26 are created.

The shape of chamber 2 may be optimized to ease the air circulation in well 44 of area 50 of the chamber without generating instabilities.

Fan 32 may be powered by means external to device 20 or by cell 2.

This self-contained device may be used in electronic equipment such as a cell phone battery charger.

Specific embodiments of the present invention have been described. Various alterations and modifications will occur to those skilled in the art. In particular, it may be provided to use a fan which enables air loaded with oxygen to enter through its periphery and air loaded with water to exit through its central portion. Further, the present invention may be adapted for fuel cells of methanol-air type, with methanol then playing the role of hydrogen.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A device comprising a chamber in which a hydrogen-air or methanol-air type fuel cell is arranged, the chamber comprising:
an upper wall in which a single opening is formed,
a lower wall on which the cell is arranged so that the surface of exposure to air of the cell faces the upper wall, and a fan arranged in the opening.

2. The device of claim 1, wherein the fan is in central position relative to the cell.

3. The device of claim 1, wherein the fan has a lateral dimension ranging between 5 and 25 mm, preferably between 10 and 20 mm.

4. The device of claim 1, wherein the fan has a surface area ranging between 25 and 425 mm², preferably between 100 and 400 mm².

5. The device of claim 1, wherein the fan is powered by the cell.

6. The device of claim 1, wherein the internal surface of the upper wall comprises a sheet of a humidity-absorbing material communicating through an auxiliary opening with the outer environment of the chamber.

7. A battery charger for a cell phone, comprising the device of claim 1.
